(19) United States
(12) Patent Application Publication
(10) Pub. No.: US 2016/0302381 A1
(43) Pub. Date: Oct. 20, 2016

(54) Mattress Enveloping Floating Pet Ramp for Providing Human Bed Access to Animals

(71) Applicant: Marc Randall Asposito, Flagler Beach, FL (US)

(72) Inventor: Marc Randall Asposito, Flagler Beach, FL (US)

(21) Appl. No.: 15/131,481

(22) Filed: Apr. 18, 2016

Related U.S. Application Data
(60) Provisional application No. 62/149,540, filed on Apr. 18, 2015.

(51) Int. Cl. A01K 1/035

(52) U.S. Cl. CPC A01K 1/035

(57) ABSTRACT

The present invention provides an apparatus for providing an animal access to and from an elevated surface, which includes a landing area, an adjustable ramp connected to said landing area, and an anchor platform connected perpendicular to the landing area for supporting the landing area and adjustable ramp to the elevated surface. The apparatus particularly solves the unmet need in that it is portable, trip-free to humans, is of sufficient length to allow for gradual access for smaller, older, sick or injured pets, can be anchored by any mattress and box spring set and is free floating. The present invention optionally includes one or side walls which are removably connected to the landing platform or ramp plank.

### CROSS-REFERENCE TO RELATED APPLICATIONS

This application claims the benefit of U.S. Provisional Application No. 62/149,540, having filing date of Apr. 18, 2015 the disclosure of which is hereby incorporated by reference in its entirety and all commonly owned.

### FIELD OF INVENTION

The present invention relates to pet ramps for providing an animal access to a human bed. More particularly, the present invention relates to portable pet ramp systems which envelop two sides of a mattress to provide a gradual access to a bed while remaining trip-free. The present invention further relates to an elevated pet ramp device particularly in a bedroom environment where a bedside pet ramp support device fits in between a mattress and mattress box spring using pressure and weight to securely elevate a support base landing area and pet ramp providing a gradual ramp access to a person's bed for a pet.

### BACKGROUND

Many people who own household pets such as dogs or cats often enjoy having the animals join them in their bed. For smaller or older animals, this can be a daunting task, and often require human assistance to lift the pet into their bed. Most owners prefer to provide ubiquitous access to the bed so that an animal can access the bed anytime without human assistance. This facilitates for an animal's comfort when the humans are not around, and allows the animal to access the bed at night without having to wake up the human for assistance. Several attempts have been offered to assist animals for accessing their owners bed. The attempts fall into two categories, steps and ramps.

Pet steps have many shortcomings that do not make them a preferred solution. First, the animals are still required to do some climbing. For older pets with arthritis, or for smaller or younger pets, climbing a set of stairs can be an impossible task, thus frustrating the purpose of an owner employing that method. Second, the steps protrude from a side of a bed creating a trip hazard for a human. Finally, pet steps are ordinarily not adjustable, thus either a particular size has to be made for a person's mattress, or a set of steps too tall or too short would be employed causing further frustration to pet owners.

Pet ramps provide a better solution to provide bed access to pets, however the current ramps available still do little to accommodate for the problems pet owners encounter. First, pet ramps are often steep. Many attempts essentially replace the steps of pet steps with a ramp. U.S. Pat. No. 5,213,060, U.S. Pat. No. 6,691,645, U.S. Pat. No. 6,968,810, U.S. Pat. No. 7,621,236, and Us are excellent examples of this type of solution to providing pet access to beds. These solutions provide a ramp too steep for some animals, particularly younger, older, or injured animals. Moreover, it is abundantly clear that using such a device would obstruct passage around a bed, thus creating a trip hazard to the humans when such a solution is employed. In addition, while some of these solutions are modular or telescoping, they can be bulky and prevent the ramp from being portable. Furthermore, no pet step or pet ramp solution offers walls for preventing the pet from falling off the ramp. Certain solutions offer side rails to the ramp which only extend perpendicular to the ramp for a brief distance only preventing an animal's paws from slipping off the edge of the ramp, but nothing offers a wall which retains the animal's body from falling off the ramp.

Finally, existing pet ramps and pet steps have platforms which rest on the floor, thus making it difficult to clean underneath without having to move or disassemble the step or ramp. While it is appreciated that some attempts, such as U.S. Pat. No. 6,968,810 have included certain devices for fitting under a mattress, those attempts do not support the weight of the ramp or stairs, and merely provide a means for securing the steps or ramp to the bed to restrict movement or creep. Thus there remains a need for a free floating pet ramp which can be anchored to an elevated surface without an additional platform to support the weight of the ramp on a lower surface.

No pet ramps exist which: are portable; are trip-free to humans; are of sufficient length to allow for gradual access for smaller, older, sick or injured pets; which can be anchored by any mattress and box spring set; which are free floating; and which has the option to include walls for retaining an animal on the pet ramp. Thus, there remains an unmet need.

### SUMMARY OF INVENTION

The present invention provides an apparatus for providing an animal access to and from an elevated surface, which includes a landing area, an adjustable ramp connected to said landing area, and an anchor platform connected perpendicular to the landing area for supporting the landing area and adjustable ramp to the elevated surface. The apparatus particularly solves the unmet need in that it is portable, trip-free to humans, is of sufficient length to allow for gradual access for smaller, older, sick or injured pets, can be anchored by any mattress and box spring set and is free floating. The present invention optionally includes one or side walls which are removably connected to the landing platform or ramp plank.

The present invention additionally provides an apparatus for providing an animal access to and from a human bed mattress which includes a landing area comprising of at least one landing plank, an adjustable ramp comprising of at least one ramp plank connected to the landing area, wherein the ramp plank is hingedly connected to the landing area to allow for the ramp plank to interface between a landing area and a lower surface, and an anchor platform comprising of an anchor plank connected perpendicular to the landing area, the anchor platform supporting the weight of the landing area and the adjustable ramp to the mattress, wherein the anchor platform is connected to the landing platform such that the anchor platform extends a distance below the landing area. The invention optionally includes side walls which are removably connected to the landing platform or the ramp plank.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a front perspective view of the inventive 10 pet ramp illustrating a 100 anchor platform, a 200 landing area and a 300 adjustable ramp. FIG. 1 further illustrates that the 100 anchor platform extends below the 200 landing area by at least one 101 adjustable or fixed support. FIG. 1 also shows that the 300 adjustable ramp may include at least one 301 ramp planks hingedly connected to the 200 landing area at any one of the 201, 202, 203 ramp connector locations.

FIG. 2 is a back perspective view of the 10 pet ramps showing the orientation of the 100 anchor platform and 200 landing area in relation to the at least one 101 adjustable or fixed support.

FIG. 3 is side view of the inventive 10 pet ramp enveloping a 11 mattress illustrating the placement of the 100 anchor platform between a 11 mattress and 12 box spring.

FIG. 4 is a rear view of the inventive pet ramp enveloping a mattress in a deployed position of use around a 13 footboard.

FIG. 5 is a front perspective view of the inventive pet ramp enveloping a mattress in a deployed position of use.

FIG. 6 is a top view of the inventive pet ramp enveloping a mattress in a deployed position of use illustrating the plurality of 201, 202, 203 ramp connector locations.

### DETAILED DESCRIPTION

The following detailed description is merely exemplary in nature and is in no way intended to limit the scope of the invention, its application, or uses, which may vary. The invention is described with relation to the non-limiting definitions and terminology included herein. These definitions and terminology are not designed to function as a limitation on the scope or practice of the invention, but are presented for illustrative and descriptive purposes only.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Generally

The present invention contains the features of an inventive pet ramp for providing access to an animal to an elevated surface, while enveloping the elevated surface to prevent a trip hazard. The inventive pet ramp includes a landing area, an adjustable ramp to be connected to the landing area, and an anchor platform connected perpendicular to the landing area. In other embodiments the inventive pet ramp includes a landing area having at least one landing plank, an adjustable ramp having at least one ramp plank hingedly connected to the landing area to allow for the ramp plank to interface between the landing area and a lower surface, and an anchor platform having at least one anchor plank connected perpendicular to the landing area and extending a distance below the landing area.

While it is intended that the inventive pet ramp be light weight in order to be able to portable and easy to pack, the inventive pet ramp can be made of many materials. Without limiting the invention to any particular material, it is appreciated that many materials are known in the art which may be lightweight or rigid in order to accomplish the purpose of the intention. In at least one embodiment the anchor platform, the landing areas and the adjustable ramp, or planks thereof, are made of a composite polymer, polyvinyl chloride (PVC), plastic, runner, Polyoxymethylene, wood, metal, or combinations thereof.

Anchor Platform

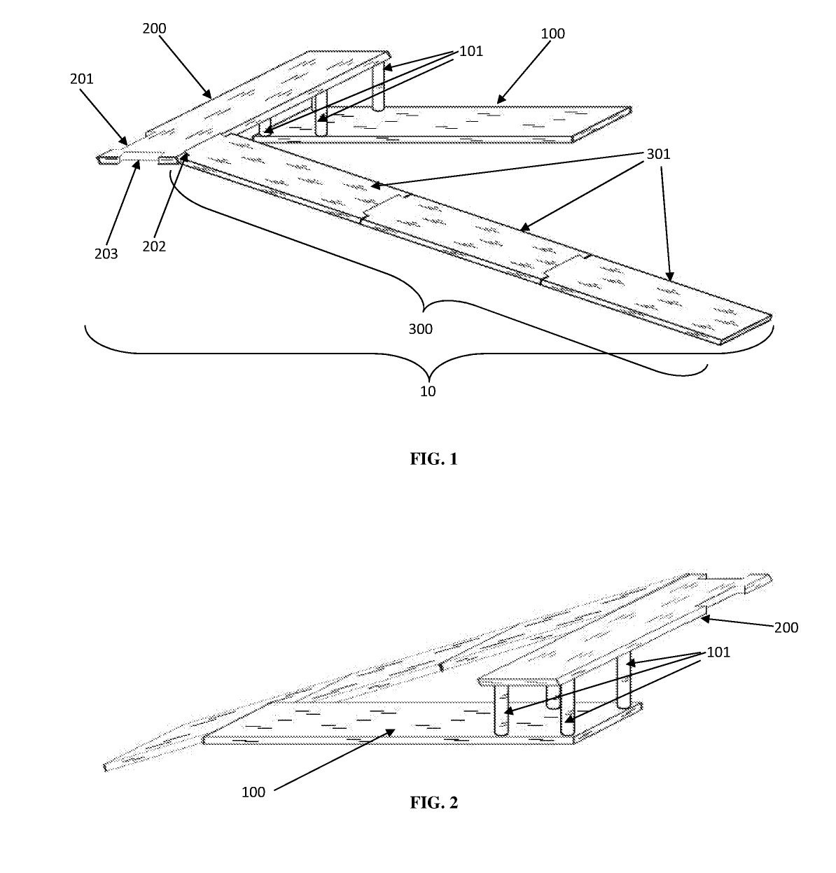

The anchor platform serves the function of supporting or anchoring the weight of the pet ramp to the elevated surface, thereby eliminating the need for the pet ramp to include any additional support from or to the ground to elevate the ramp. FIG. 1 and FIG. 2 illustrate at least one embodiment of the inventive 10 pet ramp showing the 100 anchor platform when not in use. In at least one embodiment, the anchor platform is at least one plank of sufficient length to anchor the pet ramp beneath a weighted surface to adequately support the weight of the pet ramp with or without the added weight of the animal intended to use the pet ramp. The use of an anchor platform allows for a floating landing area, thus allowing for storage or access for cleaning under the ramp when in use. It is appreciated that the anchor platform also supports the weight of the adjustable ramp when connected to the landing area.

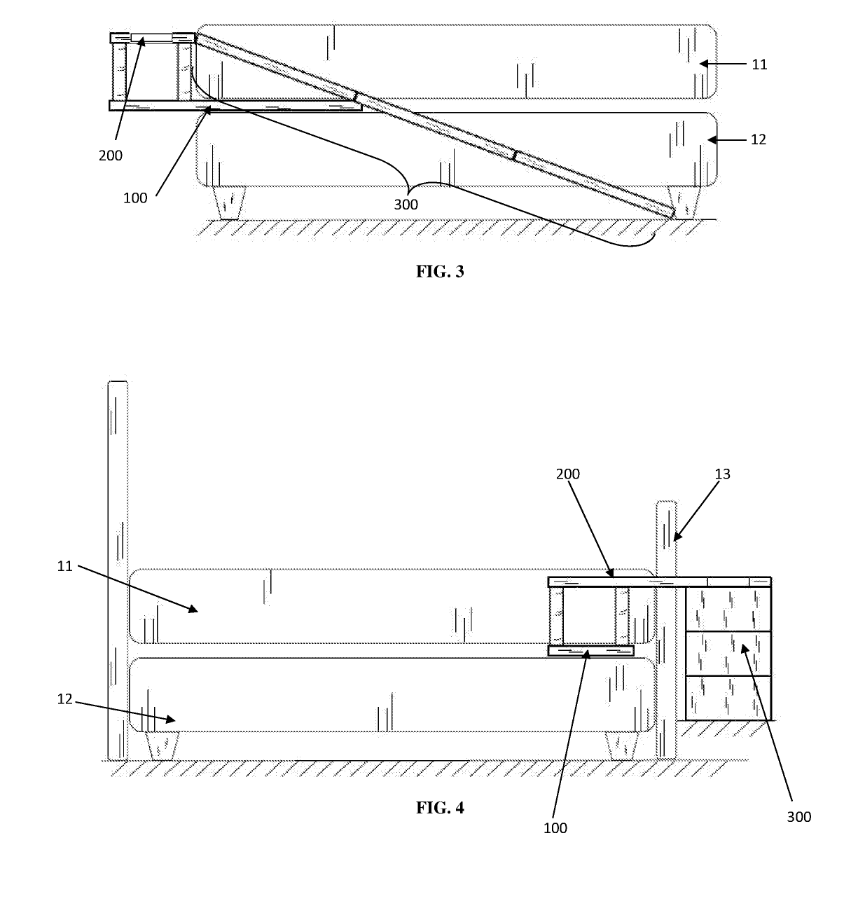

In at least one embodiment, the anchor platform is placed between a bed mattress and box spring. In this embodiment the weight of the mattress exerts a downward force upon the anchor platform allowing the anchor platform to support the weight of the landing area and the adjustable ramp. FIGS. 3-6 illustrate the 100 anchor platform while employed in use between a mattress and box spring. It is appreciated that the anchor platform may be placed on the side of the bed mattress or at the end of a bed mattress, and that the landing area and adjustable ramp can be adjustably rotated to accommodate for any orientation of the anchor platform in relation to the mattress.

In some embodiments the anchor platform is connected to the landing platform such that the anchor platform extends a distance below said landing area. This allows for the anchor platform to anchor below an elevated surface, while maintaining the height of the land area to about the height of the elevated surface. The purpose of this is to provide a seamless transition from the landing area to the elevated surface. While not being bound by any particular theory, it is also thought that having the landing area and the elevated surface in close proximity will also prevent any limbs of the animal to slip between the elevated surface and the landing area, and to prevent an animal from being inadvertently pinched caused by movement of the mattress when an animal might be lying on both the landing area and the mattress.

In at least one embodiment, the distance between the anchor platform and the landing area is adjustable by at least one or a plurality of 101 adjustable supports, as illustrated in FIG. 1 and FIG. 2. It is appreciate that many adjustable supports are known in the art which may be suitable for use in the inventive pet ramp, and nothing herein is intended to limit the invention to any particular adjustable supports. It is appreciated that one goal of the present invention is to allow for the inventive pet ramp to be portable, thus in at least one embodiment the adjustable supports should be light weight and detachable for each of transporting. In other embodiments the supports between the landing area and the anchor platform are fixed to a height for a particular use. In some embodiments the fixed supports should be able, or the adjustable supports can be adjusted, to accommodate for the thickness of a human bed mattress.

Landing Area

The landing area provides a flat area for mating against an elevated surface that an anchor platform is anchored beneath. The landing area is intended to provide a smooth transition between the adjustable ramp and the elevated surface to allow an animal easier access to the elevated surface. In some embodiments the landing area is a plank of any preferred length and preferred width. In other embodiments the landing area plank is of a preferred length, but is the same width of the adjustable ramp. In some embodiments the landing plank width is less that the anchor platform width. In some embodiments the landing platform has a width of at least three inches.

The landing area is also connected perpendicular to the anchor platform to allow the pet ramp to envelop an elevated surface, thus preventing the pet ramp from blocking passageways and becoming a trip hazard. In addition, the landing area allows for the adjustable ramp to be connected to a preferred orientation based on the particular placement of the anchor platform. While it is preferred that the adjustable ramp be connected to the landing platform such that the landing platform and adjustable ramp envelop the elevated surface, nothing herein should limit the placement of the adjustable ramp to any proscribed configuration. In at least one embodiment, the landing area includes 201, 202, 203 ramp connector locations, as illustrated in FIG. 1 and FIG. 6. In this embodiment, the adjustable ramp may be connected at any of the ramp connector locations to accommodate a user's preference on the orientation of the ramp.

Adjustable Ramp

The adjustable ramp of the inventive pet ramp is connected to the landing area. Without intending to limit the invention, it is intended that the adjustable ramp is connected to the landing area to envelope the elevated surface it is intended to provide access to such that use of the pet ramp prevents a trip hazard. In some embodiments the adjustable ramp includes at least one ramp plank. In at least one embodiment the ramp is hingedly connected to the landing area at any of the 201, 202, 203 ramp connector locations, as illustrated in FIG. 1 and FIG. 6. In at least one embodiment, the adjustable ramp or at least one ramp plank is rotationally moveable such that when the ramp is connected to the landing area that the ramp can be made to interface between the landing area and a lower surface, no matter the height of the elevated surface. In other embodiment a plurality of ramp planks are included to make up the adjustable ramp with each ramp plank rotationally movable in relation to each other by a hinge, hook hinge, or pin support.

Detachable Walls

It is appreciated that particularly with aging pets or pets suffering from hip disorders or arthritis, that slipping and falling off the adjustable ramp or landing area is a real concern to prevent further injury or suffering for the animal. In at least one embodiment, the inventive pet ramp includes side rails attached to the adjustable ramp, the adjustable ramp planks, or the landing area which prevent the feet of the animal from slipping off the pet ramp. Notwithstanding, it is further appreciated that side rails do not entirely prevent an animal from falling off the pet ramp, thus in some embodiments, the inventive pet ramp includes removable side walls for connecting to the landing platform, the adjustable ramp or any ramp plank.

### EXAMPLES

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1

A pet ramp of FIG. 1 and FIG. 2 is used to provide ubiquitous access for an animal to and from a human bed mattress. The 10 pet ramp includes a 100 anchor platform, a 200 landing area and a 300 adjustable ramp having a plurality of 301 ramp planks. The 100 anchor platform extends below the 200 landing area by a plurality of 101 adjustable supports. The 301 ramp planks hingedly connect to each other to form the 300 adjustable ramp which is connected perpendicular to the 200 landing area at the 202 ramp connector location.

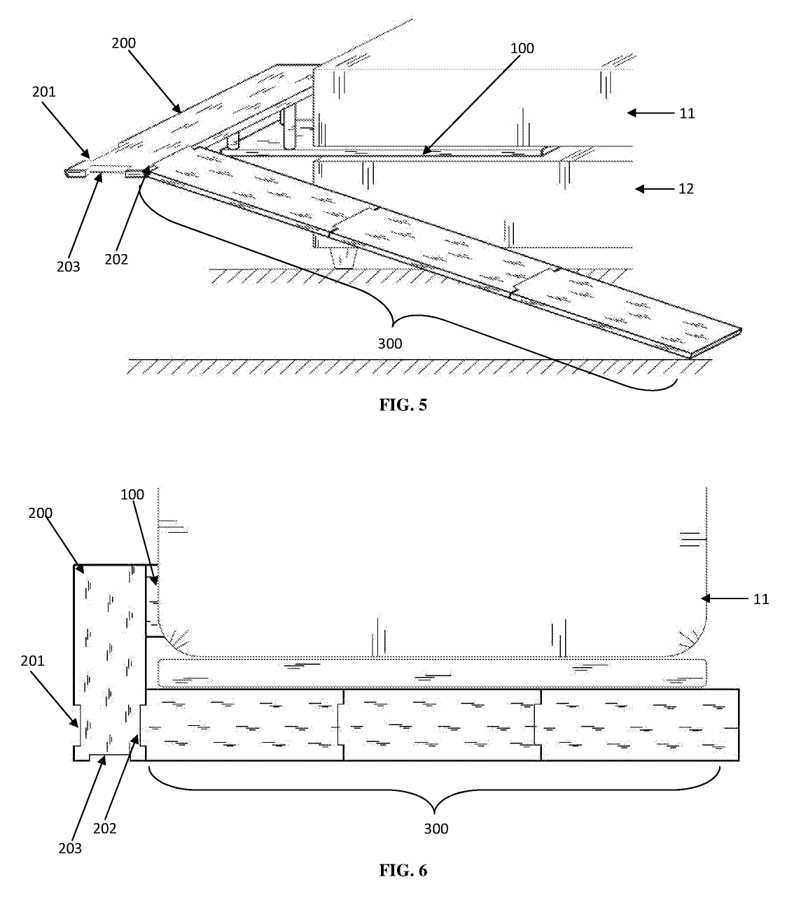

The 100 anchor platform of the 10 pet ramp is inserted between the 11 mattress and 12 box spring on one side near the foot of the bed, orienting the 200 landing platform on the side of the bed, with the 300 adjustable ramp running the length of the foot of the bed to bridge the 200 landing platform to the floor (See FIG. 3 and FIG. 5). The 10 pet ramps position is adjusted such that the 300 adjustable ramp and the 200 landing area are in contact with the bed 11 mattress and 12 box spring. Thus the 10 pet ramp is hugging the side of the bed to allow a more gradual access for the animal to access the bed, while not extending into a passageway to create a trip hazard.

### Example 2

The pet ramp of Example 1, and illustrated in FIG. 1 and FIG. 2 is provided for thus use on a bed that includes a 13 footboard, as illustrated in FIG. 4 and FIG. 6.

The 100 anchor platform of the 10 pet ramp is inserted between the 11 mattress and 12 box spring on one side near the foot of the bed, orienting the 200 landing platform on the side of the bed, with the 300 adjustable ramp running the length of the foot of the bed to bridge the 200 landing platform to the floor (See FIG. 3 and FIG. 5). The 10 pet ramps position is adjusted to accommodate for the 13 footboard such that the 300 adjustable ramp and the 200 landing area are in as close as contact as possible with the bed 11 mattress, 12 box spring and 13 footboard, simultaneously. Thus the 10 pet ramp is hugging the side of the bed and 13 footboard to allow a more gradual access for the animal to access the bed, while not extending into a passageway to create a trip hazard.

Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. An apparatus for providing an animal access to and from an elevated surface, the apparatus comprising:
a landing area;
an adjustable ramp connected to said landing area; and
an anchor platform connected perpendicular to said landing area for supporting the said landing area and said adjustable ramp to said elevated surface.

2. The apparatus of claim 1 wherein said anchor platform is connected to said landing platform such that said anchor platform extends a distance below said landing area.

3. The apparatus of claim 2 wherein the distance between said anchor platform and said landing area is adjustable, wherein said anchor platform and said landing area is connected by an adjustable support.

4. The apparatus of claim 1 wherein said distance between said anchor platform and said landing area is adjustable to accommodate for the thickness of a human bed mattress.

5. The apparatus of claim 1 wherein said adjustable ramp further comprises of at least one ramp plank that is connected to said landing area, said at least one ramp plank being rotationally moveable where the ramp plank is connected to said landing area to allow for said ramp to interface between said landing area and a lower surface.

6. The apparatus of claim 5 wherein said at least one ramp plank is a plurality of ramp planks.

7. The apparatus of claim 6 wherein said plurality of ramp planks are rotationally movable where each ramp plank is connected to each other.

8. The apparatus of claim 5 wherein a hinge, hook hinge, or pin support is used to make said ramp plank rotationally moveable.

9. The apparatus of claim 1 further comprising side walls which are removably connected to said landing platform or said at least one ramp plank.

10. The apparatus of claim 1 wherein said width of said ramp, said landing area or said anchor platform is at least three inches.

11. The apparatus of claim 1 wherein said anchor platform has a width that is greater than the width of said landing area.

12. An apparatus for providing an animal access to and from a human bed mattress, the apparatus comprising:
a landing area comprising of at least one landing plank;
an adjustable ramp comprising of at least one ramp plank connected to said landing area, wherein said ramp plank is hingedly connected to said landing area to allow for said ramp plank to interface between a landing area and a lower surface; and
an anchor platform comprising of an anchor plank connected perpendicular to said landing area, said anchor platform supporting the weight of said landing area and said adjustable ramp to said mattress, wherein said anchor platform is connected to said landing platform such that said anchor platform extends a distance below said landing area.

13. The apparatus of claim 12 wherein the distance between said anchor platform and said landing area is adjustable, wherein said anchor platform and said landing area is connected by an adjustable support.

14. The apparatus of claim 12 wherein said distance between said anchor platform and said landing area is adjustable to accommodate for the thickness of a human bed mattress.

15. The apparatus of claim 12 wherein said at least one ramp plank is a plurality of ramp planks hingedly connected to one another.

16. The apparatus of claim 12 further comprising side walls which are removably connected to said landing platform or said at least one ramp plank.
